(19) United States
(12) Patent Application Publication
(10) Pub. No.: US 2008/0283613 A1
(43) Pub. Date: Nov. 20, 2008

(54) Card Receiving Device

(75) Inventors: Heinz-Josef Hautvast, Brigachtal (DE); Torsten Wahler, Bad Durrheim (DE); Peter Wolf, Niedereschach (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: CONTINENTAL AUTOMOTIVE GMBH, HANNOVER (DE)

(21) Appl. No.: 12/093,533

(22) PCT Filed: Aug. 27, 2007
(86) PCT No.: PCT/EP07/58858

§ 371 Date: May 13, 2008

(30) Foreign Application Priority Data
Aug. 28, 2006 (DE) 10-2006-040.107.7

(51) Int. Cl. G06K 7/01

(52) U.S. Cl. 235/486

(57) ABSTRACT

A car receiving device has a receiving opening for insertion of a chip card, a closure for closing the opening, a locking unit having a locking element transferable to a locking position by way of a closing movement and a blocking unit having a blocking element transferable to a blocked position in which it blocks the locking unit brought into the locking position. A sensor system detects the locking position and monitors the course of the closing movement, wherein a sensor has a stationary sensor element. A first mobile sensor element is associated with the locking element and triggers a switching process of the sensor in a first relative position. A second mobile sensor element is associated with the blocking element and triggers a switching process of the sensor in a second relative position so that the sensor can detect the course of the closing movement.

### CROSS-REFERENCE TO RELATED APPLICATIONS

This application is a U.S. national stage application of International Application No. PCT/EP2007/058858 filed Aug. 27, 2007, which designates the United States of America, and claims priority to German application number 10 2006 040 107.7 filed Aug. 28, 2006, the contents of which are hereby incorporated by reference in their entirety.

### TECHNICAL FIELD

The present invention relates to a card receiving device, in particular for a tachograph in a motor vehicle.

### BACKGROUND

Card receiving devices will be used in the future generation of tachographs. In these so-called digital tachographs (DTCO), the tachograph charts used to date will be replaced by a smart card for registering the driver- and vehicle-specific data. This smart card is inserted into a device, the DTCO, during use of the vehicle. According to applicable legal requirements, the card has to be blocked and retained in the device. In addition, at least one blocking part has to be checked during recording of the data on the smart card. Card receiving devices which meet these legal specifications are known. For example, DE 103 21 215 A1 discloses a card receiving device in which a first sensor in the form of a forked light barrier detects the position of the blocking element, and a second sensor, which is likewise in the form of a forked light barrier, detects the retaining position of the retaining unit. However, it has been found that designing a card receiving device with two forked light barriers is complex and expensive.

### SUMMARY

A card receiving device in which blocking and retention of the smart card are monitored can be provided, for example, in a simpler and more cost-effective manner. According to an embodiment, a card receiving device may comprise a receiving opening for inserting a smart card, a closure for closing the receiving opening, a blocking unit with a blocking element which can be moved, by way of a closing movement, to a blocking position in which it blocks the closure, a retaining unit with a retaining element which can be moved to a retaining position in which it retains the blocking unit which is in the blocking position, a sensor system for detecting the blocking state and for monitoring the progress of the closing movement, comprising a sensor comprising a stationary sensor element, a first moving sensor element, which is associated with the blocking element, triggering a switching process of the sensor in a first relative position, and a second moving sensor element, which is associated with the retaining element and triggers a switching process of the sensor in a second relative position, so that the progress of the closing movement can be detected by means of the sensor.

According to a further embodiment, the second relative position may be the retaining position. According to a further embodiment, the first relative position may lie between the unblocked starting position and the blocking position. According to a further embodiment, a data-transferring connection to the smart card to be received may be made only when the retaining element is in the retaining position. According to a further embodiment, the sensor may be in the form of a reflection light barrier, with the stationary sensor element having a transmitter and a receiver, and the moving sensor elements, which are associated with the blocking element and the retaining element, being reflection areas. According to a further embodiment, an area can be provided on the blocking element, which area absorbs the light emitted by the sensor, diffusely scatters it and reflects it away from the receiver when said area is between the starting position and the blocking position in the active region of the reflection light barrier. According to a further embodiment, a wall, which forms a screen, is formed on the blocking element and/or the retaining element next to the reflection areas on at least one side, in order to protect the reflection light barrier from the incidence of external light.

According to another embodiment, a method for receiving a smart card by means of a card receiving device, may comprise the steps of: inserting the smart card into a receiving opening in the card receiving device during an insertion phase, moving a blocking unit, by way of a closing movement, to a blocking position, in which a blocking element blocks the receiving opening for the smart card, during a blocking phase after the insertion phase, and moving a retaining unit to a retaining position, in which a retaining element retains the blocking unit, during a securing phase following the blocking phase, wherein a first moving sensor element, which is associated with the blocking element, triggers a switching process of the sensor together with a stationary sensor element of a sensor of a sensor system for detecting the blocking state and for monitoring the progress of the closing movement in a first relative position during the blocking phase, and wherein the first moving sensor element is initially detected during the closing process, and a second moving sensor element, which is associated with the retaining element, then triggers a switching process of the sensor together with the one stationary sensor element in a second relative position during the securing phase.

According to a further embodiment, the sensor may detect the blocking element in a relative position between the unblocked starting position and the blocking position, generates a first signal and transmits this signal to a central control system. According to a further embodiment, the sensor may detect the retaining element in the retaining position, generates a second signal and transmits the signal to the central control system. According to a further embodiment, the sensor may transmit at least one signal to the central control system at the beginning and/or at the end of the retaining operation for the blocking unit. According to a further embodiment, the sensor may permanently check the position of the retaining element in the retaining position and permanently reports the detected position to the central control system. According to a further embodiment, data may be transmitted between the smart card and the card receiving device only when the retaining position of the retaining unit is reported by the sensor. According to a further embodiment, the smart card may be drawn-in by means of a motor and the motor may be switched off when the retaining position of the retaining unit is detected and reported by the sensor. According to a further embodiment, the first signal, which is generated by the sensor during the blocking phase and is transmitted to the central control system starting from the beginning of the blocking phase, triggers a time recording operation for identifying the card drawing-in operation in the central control system, and a process for discharging the smart card is initiated when a specific duration of the process of blocking is exceeded, with the first signal being checked and/or the second signal being checked by the central control system after a defined time starting from triggering of the time recording operation, and the smart card being discharged when the first signal is present and/or when the second signal is absent.

### BRIEF DESCRIPTION OF THE DRAWINGS

Two exemplary embodiments of the invention are described in greater detail below with reference to the attached drawings, in which:

FIG. 1 shows a schematic plan view of a detail of a first embodiment of a card receiving device with a smart card not yet fully inserted;

FIG. 2 shows the card receiving device according to FIG. 1 during the blocking phase;

FIG. 3 shows the card receiving device according to FIG. 1 with the smart card blocked;

FIG. 4 shows the card receiving device according to FIG. 1 with retained blocking;

FIG. 5 shows a retaining element of the card receiving device according to FIG. 1;

FIG. 6 shows a blocking element of the card receiving device according to FIG. 1;

FIG. 7 shows a detail of a second embodiment of a card receiving device with a smart card not yet inserted;

FIG. 8 shows the card receiving device according to FIG. 7 with a blocked smart card; and

FIG. 9 shows the card receiving device according to FIG. 7 with retained blocking.

### DETAILED DESCRIPTION

According to various embodiments, a second moving sensor element may be provided, which is associated with the retaining element and triggers a switching process of the sensor in a second relative position, so that the progress of the closing movement can be detected by means of the sensor.

The advantage of the card receiving device according to various embodiments is that only one further sensor element is required to detect blocking and retention. Instead of monitoring the closing movement by means of checking a Boolean AND function of two signals by two sensors which each comprise two interacting sensor elements, monitoring can be performed by the interaction between two moving sensor elements and the one stationary sensor element in different movement phases. In addition to saving material costs for a second stationary sensor element, which is now no longer required, and its electrical connections, this also permits reduced outlay on installation and a smaller space requirement. The switching processes involve, for example, changing an applied signal, for example from ON to OFF or from OFF to ON.

In an embodiment, the second relative position corresponds to the retaining position. This permits simple and efficient checking of retention. This ensures that cancellation of retention can be detected by the sensor. On account of the structural connection of the blocking unit and the retaining unit in the blocking position, blocking, which, as already mentioned, has to be present during operation, is simultaneously monitored too. The beginning and/or the end of retention of the blocking unit can be detected by means of a change in the signal of the sensor. Checking is preferably performed permanently, in order to be able to detect even small interruptions in retention.

According to one embodiment, the first relative position lies between the unblocked starting position and the blocking position. As a result, the process of blocking can be detected and any manipulation of the blocking process can be identified.

According to another embodiment, a data-transferring connection to the smart card to be received is made only when the retaining element is in the retaining position. This ensures that the tachograph provides data only when a smart card is securely held in the tachograph and retained in the card receiving device. Therefore, the data contained in tachograph cannot be accessed without authorization.

In another embodiment, the sensor is in the form of a reflection light barrier, with the stationary sensor element, as an electrical part of the sensor, having a transmitter and a receiver which are arranged in a housing and point in the same spatial direction. The moving sensor elements, which are associated with the blocking element and the retaining element, are each in the form of a reflection area. This can be achieved, for example, by a film or foil being adhesively bonded, a paint being applied to the elements or the surface being designed to be reflective. The design in the form of a reflection light barrier has the advantage that the transmitter and receiver which are to be electrically connected in each case are not arranged in two different housings which react to an interruption in the optical axis, as is the case in a forked light barrier. If a reflective object is positioned in front of the reflection light barrier, the light from the transmitter is reflected and strikes the receiver. In addition to detection by an optical sensor, detection can also be performed by another type of sensor, for example inductively, capacitively and/or mechanically.

In order to ensure that no light from the transmitter is reflected onto the receiver in the blocking position, an area can be provided on the blocking element, which area absorbs the light emitted by the transmitter, diffusely scatters it and reflects it away from the receiver when said area is between the starting position and the blocking position in the active region of the reflection light barrier. In the retaining position, the second moving sensor element is arranged between the area which absorbs and/or diffusely scatters the light and the reflection light barrier.

According to yet a further embodiment, provision is made for a wall, which forms a screen, to be formed on the blocking element and/or the retaining element next to the reflection areas on at least one side, in order to protect the reflection light barrier from the incidence of external light. As a result, operational ability is also ensured when, for example, direct sunlight strikes the tachograph and should have entered the housing through a gap.

According to another embodiment, in a method for receiving a smart card by means of a card receiving device, the smart card is inserted into a receiving opening in the card receiving device during an insertion phase, a blocking unit moves, by way of a closing movement, to a blocking position, in which a blocking element blocks the receiving opening for the smart card, during a blocking phase after the insertion phase, and a retaining unit is moved to a retaining position, in which a retaining element retains the blocking unit, during a securing phase following the blocking phase, with a first moving sensor element, which is associated with the blocking element, triggering a switching process of the sensor together with a stationary sensor element of a sensor of a sensor system for detecting the progress of the closing movement in a first relative position during the blocking phase. According to various embodiments, the first moving sensor element is initially detected. Then, a second moving sensor element, which is associated with the retaining element, interacts with the stationary sensor element in a second relative position and triggers a switching process of the sensor during the securing phase, as a result of which the sensor detects the progress of the closing movement of the blocking element.

The advantage of the method is that the blocking state and the progress of the closing movement are detected by a single sensor. This is made possible by the two moving sensor elements interacting with the one stationary sensor element at different times. The switching processes involve, for example, changing an applied signal, for example from ON to OFF or, conversely, from OFF to ON.

According to a further embodiment, the first signal, which is generated by the sensor during the blocking phase and is transmitted to the central control system starting from the beginning of the blocking phase, triggers a time recording operation for identifying the card drawing-in operation in the central control system, and a process for discharging the smart card is initiated when a specific duration of the process of blocking is exceeded, with the first signal being checked and/or the second signal being checked by the central control system after a defined time starting from triggering of the time recording operation, and the smart card being discharged when the first signal is present and/or when the second signal is absent. These simple measures provide a method for identifying an attempt to manipulate the smart card. If, for example during an attempt at manipulation, the card is firmly held, so that it cannot be drawn-in as intended, this is identified by the central control system and the smart card is rejected. In addition, the method serves to protect the mechanism against damage.

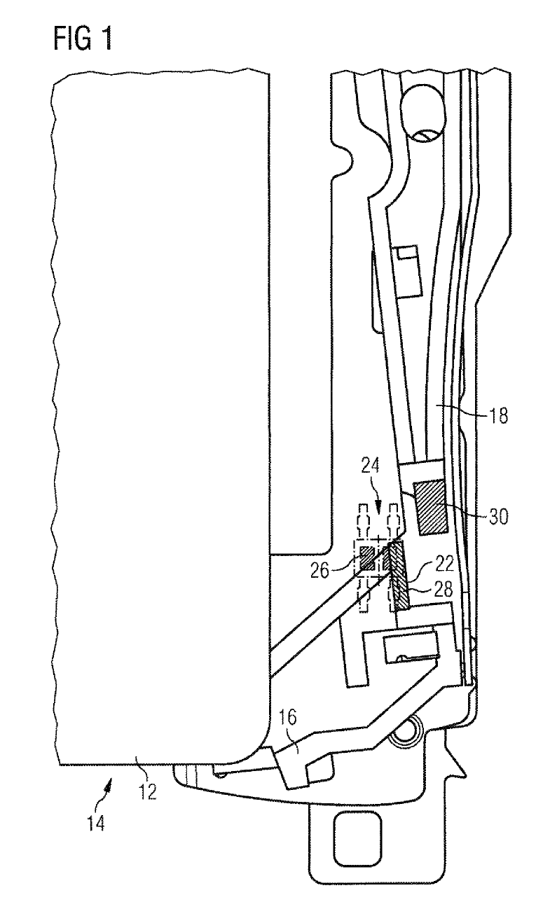

FIG. 1 shows a card receiving device for a tachograph, in which card receiving device a smart card 12 is inserted into a receiving opening 14. In order to close the receiving opening 14, a closure which has blocking elements 16, of which only the right-hand side is shown in the figure, is provided on both sides of the receiving opening. The blocking element 16 can be moved, by way of a closing movement, to a blocking position in which it blocks the receiving opening 14. After the smart card 12 is drawn into the card receiving device, the blocking element 16 is, for closing purposes, pivoted by means of a drive (not illustrated) and gear mechanism in front of the smart card 12 such that said smart card can no longer be withdrawn from the card receiving device.

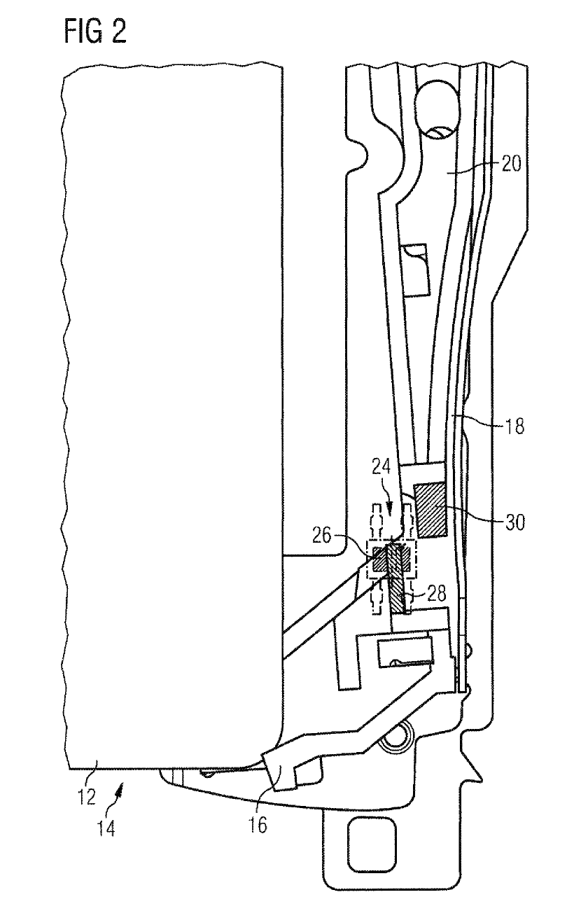

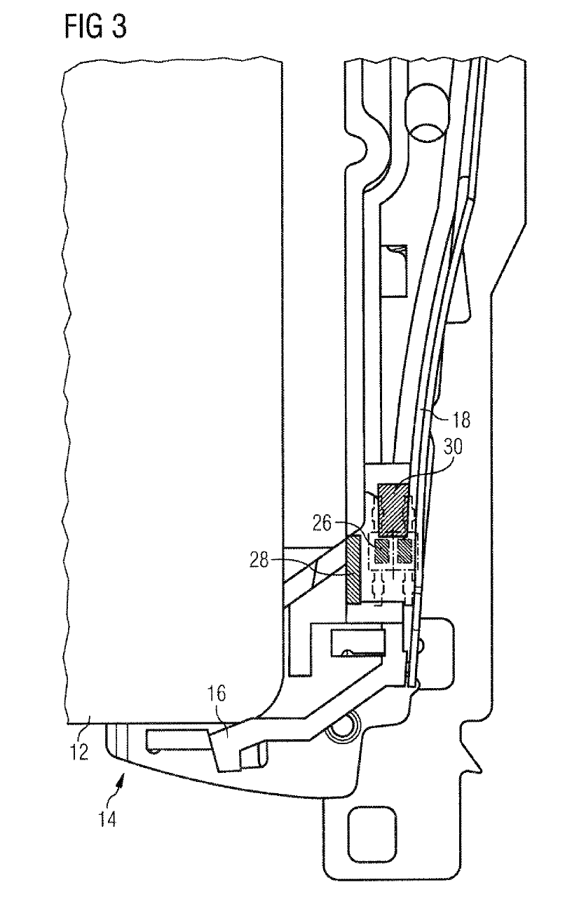

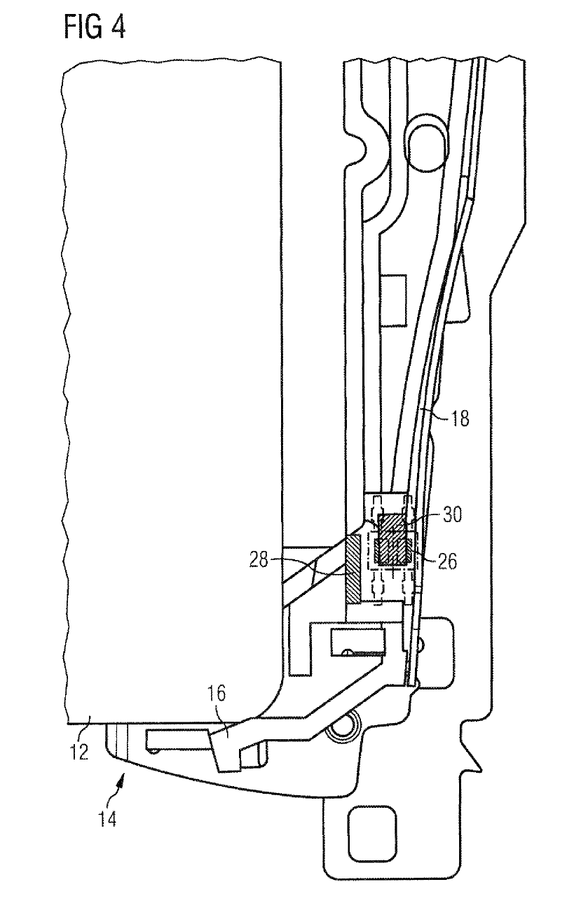

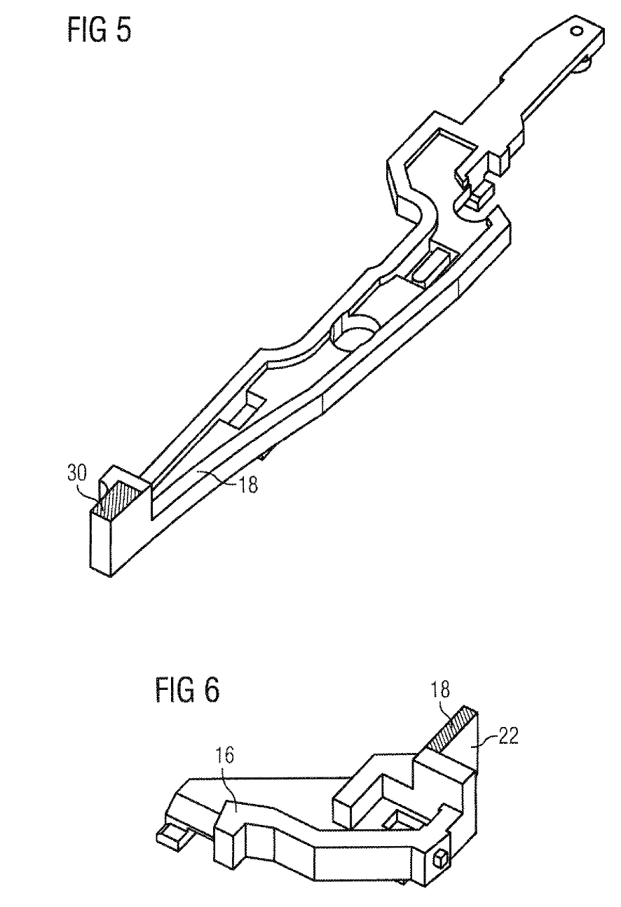

The movement of the blocking element 16 is shown by the sequence of FIGS. 1 to 4. In FIG. 1, the blocking element 16 is in an unblocked starting position. In FIG. 2, the blocking element 16 is shown during the pivoting-in movement. In FIG. 3 and FIG. 4, the blocking element 16 is in the blocking position. In order for the blocking element 16 to be able to execute the pivoting-in movement for blocking purposes, the smart card 12 has to be in the rear position, that is to say it must be fully drawn-in.

A retaining unit with a retaining element 18 is provided in order to retain the blocking element 16 in the blocking position, it being possible for said retaining element to be moved to a retaining position in which it retains the blocking unit. The retaining element 18 is held on a base support 20 of the blocking unit, which base support transmits the pivoting movement from the gear of the drive to the blocking element 16, such that it can be displaced in the longitudinal direction. The retaining element 18 therefore follows the pivoting-in movement of the blocking unit in relation to the card receiving device and maintains its relative position to the blocking element 16 during the pivoting-in movement. In order to retain the blocking unit, the retaining element 18 is pushed behind the protrusion 22 of the blocking element 16 when the blocking element 16 is in the blocking position. As a result, the blocking element 16 is retained in its position.

In order to detect the progress of the closing movement, a sensor 24 comprising a stationary sensor element 26 and a first moving sensor element 28 is provided, said moving sensor element 28 interacting with the stationary sensor element 26 in a first relative position and triggering a switching process of the sensor 24 as a result. The first moving sensor element 28 is associated with the blocking element 16. A second moving sensor element 30 is associated with the retaining element 18 and interacts with the stationary sensor element 26 in a second relative position and triggers a switching process of the sensor 24 as a result.

The sensor 24 is an optical sensor in the form of a reflection light barrier. The stationary sensor element 26 has a transmitter and a receiver which are arranged in a housing and point in the same spatial direction. In this case, the transmitter and receiver are spatially separated such that the light from the transmitter cannot directly strike the receiver. If a reflective object is positioned in front of the reflection light barrier, the light from the transmitter is reflected and strikes the receiver. In this case, only the stationary sensor element 26 requires electrical connections. The moving sensor elements 28, 30 are each in the form of simple reflection areas.

In the starting position, the reflection area of the blocking element 16 is not yet in the region of the reflection light barrier. After the beginning of the pivoting-in movement, the reflection area of the blocking element 16 moves into the light beam from the reflection light barrier whose reflection is identified, following which a switching process is triggered and a signal is transmitted to a central control system (not shown). The switching process involves changing the applied signal from OFF to ON. Shortly before reaching the blocking position, the reflection area of the blocking element 16 leaves the region in which it interacts with the reflection light barrier. This leads to a signal no longer being emitted by the reflection light barrier. Consequently, the signal is applied from the beginning until almost the end of the blocking operation, that is to say the central control system is able to identify the progress of the blocking operation.

After the blocking phase is concluded, the retaining element 18 moves behind the blocking element 16 into the retaining position in which the reflection area of the retaining element 18 enters the light beam from the reflection light barrier. The sensor 24 detects the retaining element 18 and generates a second signal which is transmitted to the central control system, that is to say a switching process is triggered in which the applied signal changes from OFF to ON. Since a simple sensor 24 is usually not able to distinguish between the two reflection areas, the second signal is identified with the aid of a gap which is present between the two signals. The central control system then switches off the drive for drawing-in the smart card 12. As soon as the retaining element 18 behind the blocking element 16 is again moved out, this is detected by the sensor 24 which sends a signal to the central control system. Since the retaining element 18 and the blocking element 16 are mechanically coupled to one another, the position of the retaining element 18 in the retaining position can be permanently checked and reported to the central control system by the sensor 24, in order to meet the statutory requirements. Checking the position of the retaining element 18 ensures that data is transmitted between the smart card 12 and the tachograph only when the retaining position of the retaining unit is reported by the sensor 24.

In order to ensure that the smart card 12 is drawn-in correctly, a time recording operation is triggered by the first signal, which is generated by the sensor 24 during the blocking phase and is transmitted to the central control system starting from the beginning of the blocking phase, in order to determine the duration of the applied first signal. When the smart card is drawn-in with correct blocking, the first signal is applied to the central control system only for a specific duration. When the smart card is drawn-in incorrectly, in the case of which correct blocking does not take place, the signal does not decrease within the disclosed time. The drawing-in operation can be monitored by the first signal being checked after a prescribed time interval. If the first signal is still applied, this is proof of a faulty drawing-in operation, with the result that the central control system can initiate a process for discharging the smart card 12. However, the blocking process can also be monitored by the time recording operation being triggered by the first signal at the beginning of the blocking phase and the second signal, which is produced by the retaining element in the case of correct blocking, being checked after a prescribed time interval. If the second signal is not applied, the process for discharging the smart card 12 is initiated by the central control system. The smart card is ejected firstly with the aim of protecting the mechanism against damage and secondly, for security reasons, to prevent manipulation when a smart card 12 is correctly inserted. In order to additionally prevent manipulation when a smart card 12 is correctly inserted, a closure flap (not shown), which automatically closes the receiving opening 14 when the smart card 12 is fully inserted, is provided in the region of the receiving opening 14.

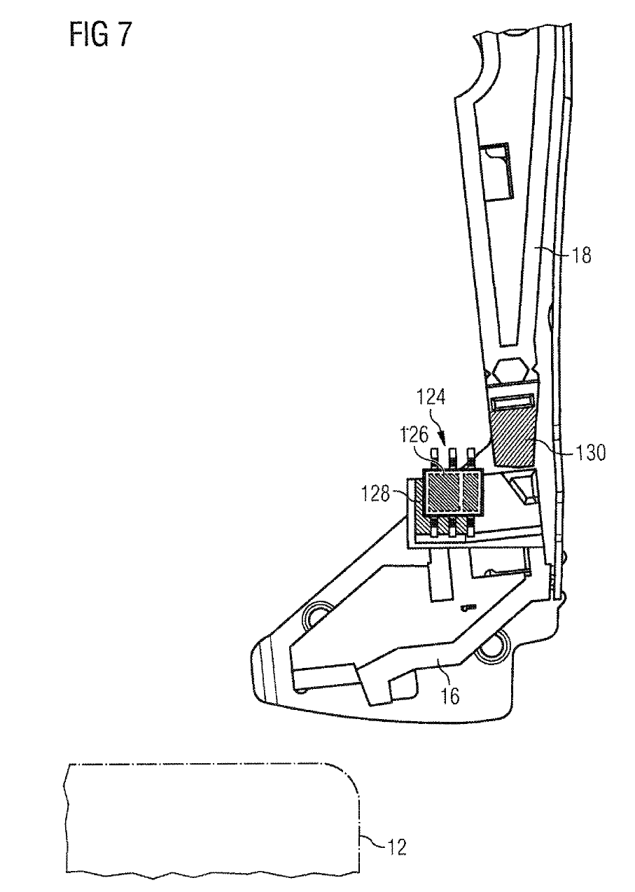

FIGS. 7 to 9 illustrate a second embodiment of a card receiving device. Apart from the sensor arrangement, the switching processes triggered by it and the generated signals, the second embodiment corresponds to the first embodiment, for which reason the same reference symbols are used for corresponding features. Therefore, only the differences are discussed in the text which follows.

FIG. 7 shows a card receiving device with a smart card 12 not yet inserted. In order to detect the closing movement, a sensor 124 comprising a stationary sensor element 126, a first moving sensor element 128 which is associated with the blocking element 16, and a second moving sensor element 130 which is associated with the retaining element 18, is provided. The sensor 124 is an optical sensor in the form of a reflection light barrier, with reference being made to the designs relating to the reflection light barrier of the sensor 24 of the first embodiment. The first moving sensor element 128, which is a simple reflection area, triggers a switching process of the sensor 124 in a first relative position, with the first relative position being the unblocked starting position. Therefore, a first signal is applied to a central control system (not shown) at the beginning of the blocking process.

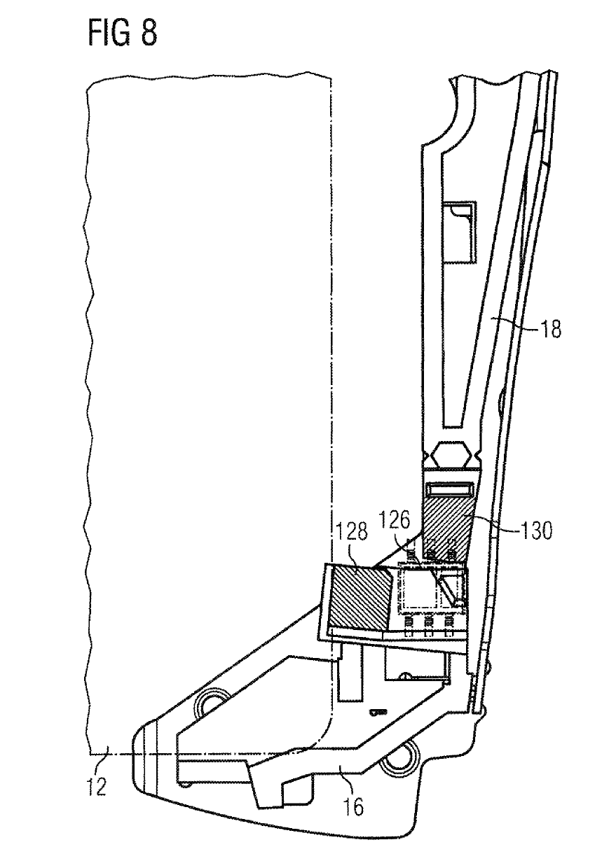

After the smart card 12 is inserted, the blocking element 16 moves, by way of a closing movement, to the blocking position shown in FIG. 8, with the result that the smart card 12 can no longer be withdrawn from the card receiving device. In the process, the reflection area of the blocking element 16 moves out of the light beam of the reflection light barrier, with the result that the signal is no longer applied, that is to say a switching process from ON to OFF is triggered, with the result that the signal to the central control system decreases.

As a result, the time recording operation which is already described in the first embodiment is triggered.

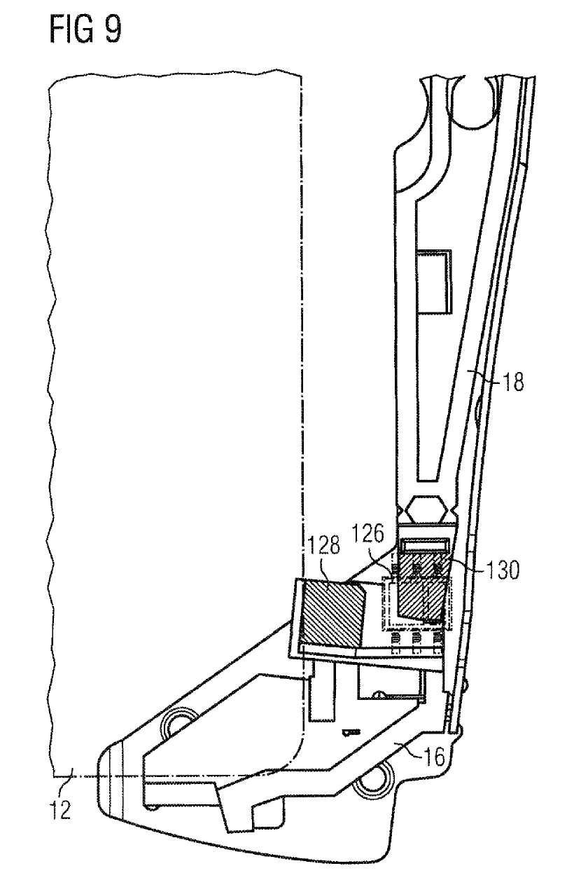

After conclusion of the blocking phase, the retaining element 18 moves behind the blocking element 16 to the retaining position which is illustrated in FIG. 9. In the process, the second moving sensor element 130, which is a simple reflection area, enters the light beam of the reflection light barrier and triggers a switching process of the sensor 124 from OFF to ON in a second relative position. The second relative position is the retaining position, that is to say a second signal is applied to the central control system in the retaining position.

In order to monitor the drawing-in operation, the second signal is checked in conjunction with the time recording operation, that is to say, in the second embodiment, the drawing-in operation is detected not by a signal decrease, as in the first embodiment, but by a signal increase since no signal is applied during the blocking operation and the second signal is first triggered during the retaining operation.

The tachograph comprising the card receiving device usually has a similar format to a car radio. Since a printer with an associated roll of paper is also accommodated in the tachograph, a very low installation height is provided for the card receiving device. A printed circuit board divides the tachograph into an upper half comprising the printer module and a lower half comprising the card receiving device. The reflection light barrier is therefore fixed on the lower face of the printed circuit board. As a result of fixing using SMD technology, no additional lines or associated connectors are required for the sensor 24. In addition, a reflection light barrier requires a lower installation height.

1. A card receiving device comprising:
a receiving opening for inserting a smart card,
a closure for closing the receiving opening,
a blocking unit with a blocking element which can be moved, by way of a closing movement, to a blocking position in which it blocks the closure,
a retaining unit with a retaining element which can be moved to a retaining position in which it retains the blocking unit which is in the blocking position,
a sensor system for detecting the blocking state and for monitoring the progress of the closing movement, comprising:
a sensor comprising a stationary sensor element,
a first moving sensor element, which is associated with the blocking element, triggering a switching process of the sensor in a first relative position, and
a second moving sensor element, which is associated with the retaining element and triggers a switching process of the sensor in a second relative position, so that the progress of the closing movement can be detected by means of the sensor.

2. The card receiving device according to claim 1, wherein the second relative position is the retaining position.

3. The card receiving device according to claim 1, wherein the first relative position lies between the unblocked starting position and the blocking position.

4. The card receiving device according to claim 1, wherein a data-transferring connection to the smart card to be received is made only when the retaining element is in the retaining position.

5. The card receiving device according to claim 1, wherein the sensor is in the form of a reflection light barrier, with the stationary sensor element having a transmitter and a receiver, and the moving sensor elements, which are associated with the blocking element and the retaining element, being reflection areas.

6. The card receiving device according to claim 1, wherein an area is provided on the blocking element, which area absorbs the light emitted by the sensor, diffusely scatters it and reflects it away from the receiver when said area is between the starting position and the blocking position in the active region of the reflection light barrier.

7. The card receiving device according to claim 1, wherein a wall, which forms a screen, is formed on the blocking element or the retaining element next to the reflection areas on at least one side, in order to protect the reflection light barrier from the incidence of external light.

8. A method for receiving a smart card by means of a card receiving device, the method comprising the steps of:
inserting the smart card into a receiving opening in the card receiving device during an insertion phase,
moving a blocking unit, by way of a closing movement, to a blocking position, in which a blocking element blocks the receiving opening for the smart card, during a blocking phase after the insertion phase, and
moving a retaining unit to a retaining position, in which a retaining element retains the blocking unit, during a securing phase following the blocking phase, wherein a first moving sensor element, which is associated with the blocking element, triggers a switching process of the sensor together with a stationary sensor element of a sensor of a sensor system for detecting the blocking state and for monitoring the progress of the closing movement in a first relative position during the blocking phase, and wherein the first moving sensor element is initially detected during the closing process, and a second moving sensor element, which is associated with the retaining element, then triggers a switching process of the sensor together with the one stationary sensor element in a second relative position during the securing phase.

9. The method according to claim 8, wherein the sensor detects the blocking element in a relative position between the unblocked starting position and the blocking position, generates a first signal and transmits this signal to a central control system.

10. The method according to claim 8, wherein the sensor detects the retaining element in the retaining position, generates a second signal and transmits the signal to the central control system.

11. The method according to the claim 10, wherein the sensor transmits at least one signal to the central control system at the beginning or at the end of the retaining operation for the blocking unit.

12. The method according to claim 10, wherein the sensor permanently checks the position of the retaining element in the retaining position and permanently reports the detected position to the central control system.

13. The method according to claim 10, wherein data is transmitted between the smart card and the card receiving device only when the retaining position of the retaining unit is reported by the sensor.

14. The method according to claim 8, wherein the smart card is drawn-in by means of a motor and the motor is switched off when the retaining position of the retaining unit is detected and reported by the sensor.

15. The method according to claim 10, wherein the first signal, which is generated by the sensor during the blocking phase and is transmitted to the central control system starting from the beginning of the blocking phase, triggers a time recording operation for identifying the card drawing-in operation in the central control system, and a process for discharging the smart card is initiated when a specific duration of the process of blocking is exceeded, with the first signal being checked or the second signal being checked by the central control system after a defined time starting from triggering of the time recording operation, and the smart card being discharged when the first signal is present or when the second signal is absent.

16. The method according to claim 10, wherein the sensor transmits at least one signal to the central control system at the beginning and at the end of the retaining operation for the blocking unit.

17. The method according to claim 10, wherein the first signal, which is generated by the sensor during the blocking phase and is transmitted to the central control system starting from the beginning of the blocking phase, triggers a time recording operation for identifying the card drawing-in operation in the central control system, and a process for discharging the smart card is initiated when a specific duration of the process of blocking is exceeded, with the first signal being checked and the second signal being checked by the central control system after a defined time starting from triggering of the time recording operation, and the smart card being discharged when the first signal is present and when the second signal is absent.

18. The card receiving device according to claim 1, wherein a wall, which forms a screen, is formed on the blocking element and the retaining element next to the reflection areas on at least one side, in order to protect the reflection light barrier from the incidence of external light.
